(19) United States
(12) Patent Application Publication
(10) Pub. No.: US 2013/0120289 A1
(43) Pub. Date: May 16, 2013

(54) INFORMATION PROCESSING APPARATUS AND METHOD OF CONTROLLING SAME

(71) Applicant: CANON KABUSHIKI KAISHA, Tokyo (JP)

(72) Inventor: Hidekazu Seto, Tokyo (JP)

(73) Assignee: CANON KABUSHIKI KAISHA, Tokyo (JP)

(21) Appl. No.: 13/633,985

(22) Filed: Oct. 3, 2012

(30) Foreign Application Priority Data
Nov. 16, 2011 (JP) 2011-251021

(51) Int. Cl. G06F 3/041

(52) U.S. Cl. 345/173

(57) ABSTRACT

An information processing apparatus having a display unit equipped with a touch panel is provided. A movement detection unit detects the amount of movement of a body contacting the touch panel, and a number detection unit detects the number of bodies. An identification identifies an object being displayed on the display unit, the object having been designated by a body contacting the touch panel. A control unit decides a manipulated variable of the object and controls display of the object in accordance with the amount of movement of the body contacting the touch panel and the number of bodies.

### BACKGROUND OF THE INVENTION

1. Field of the Invention

The present invention relates to an information processing apparatus having a touch panel and to a method of controlling this apparatus.

2. Description of the Related Art

An information terminal equipped with a display unit (a touch-screen display) having a touch-sensitive panel enables one to perform a move operation for moving an object on the screen by sliding one's finger along the screen, and a flick operation for starting scrolling by adopting a finger-flicking action as a trigger. An example of a technique for enhancing the convenience of these operations is to change between implementation of the move and the scroll operation by judging whether or not multiple fingers are contacting the touch panel (for example, see the specification of Japanese Patent Laid-Open No. 11-102274). A further technique for enhancing the convenience of scroll processing is to change the amount of scrolling on the screen using a previously registered scrolling amount for every scroll position in accordance with the display position of the object that is to be scrolled (for example, see the specification of Japanese Patent Laid-Open No. 2002-244641).

With the conventional operation for moving an object, performing such an operation to move the object just a little is difficult. For example, if it is desired to move a certain display object by one pixel on the screen, there are instances where the object is moved by two or more pixels, or not moved at all, owing to an error in the coordinate-sensing accuracy of the touch panel or as a result of a trembling finger.

Further, the conventional scroll operation offers little user friendliness in terms of scrolling a large quantity of data. For example, with the conventional scroll operation, scrolling speed can be changed based upon the speed (strength) of the finger-flicking action in the flick operation or upon the previously registered scrolling amount. However, scrolling at a speed greater than a predetermined value cannot be achieved. Although overall scrolling speed can be raised by enlarging this predetermined value, such an expedient will make it difficult to implement low-speed scrolling. Although this problem can be solved by changing the predetermined value in accordance with the circumstances, this will necessitate an operation for changing the predetermined value and is undesirable in terms of user friendliness.

### SUMMARY OF THE INVENTION

The present invention seeks to solve these problems encountered in the prior art.

The present invention provides highly user-friendly control of object manipulation by controlling manipulated variables such as movement and scrolling of a displayed object in accordance with amount of movement of a body contacting a touch panel and the number of such bodies.

According to one aspect of the present invention, there is provided an information processing apparatus having a display unit equipped with a touch panel, comprising: a movement detection unit configured to detect amount of movement of a body contacting the touch panel; a number detection unit configured to detect a number of bodies contacting the touch panel; an identification unit configured to identify an object being displayed on the display unit, the object having been designated by a body contacting the touch panel; and a control unit configured to decide a manipulated variable of the object and control display of the object in accordance with the amount of movement detected by the movement detection unit and the number of bodies detected by the number detection unit.

Further features of the present invention will become apparent from the following description of exemplary embodiments (with reference to the attached drawings).

### BRIEF DESCRIPTION OF THE DRAWINGS

FIG. 1 is a schematic view illustrating an environment in which use is made of an information terminal equipped with a touch screen according to an embodiment of the present invention;

FIG. 2 is a block diagram illustrating the hardware configuration of an information terminal according to an embodiment;

FIGS. 3A to 3C are diagrams useful in describing an example of position information representing states of contact between a touch panel and fingers;

FIG. 4 is a flowchart useful in describing an example in which the state of contact between a touch panel and fingers is sensed and processing conforming thereto executed in an information terminal according to a first embodiment;

FIG. 5 is a flowchart useful in describing processing, which corresponds to the processing of step S107 in FIG. 4, in a case where a finger touching a touch panel is moved in the first embodiment;

FIG. 6 is a flowchart useful in describing processing, which corresponds to the processing of step S109 in FIG. 4, in a case where fingers are flicked on a touch panel;

FIGS. 7A and 7B are diagrams useful in describing an example in which a screen is scrolled by moving contacting fingers on a job history screen displayed on the display unit of an information terminal according to the first embodiment;

FIGS. 8A and 8B are diagrams useful in describing movement of an image on the display unit of an information terminal according to a second embodiment;

FIG. 9 is a flowchart useful in describing page-turning processing conforming to number of fingers used in an information terminal according to a third embodiment; and

FIGS. 10A and 10B are diagrams useful in describing page-turning processing according to a third embodiment.

### DESCRIPTION OF THE EMBODIMENTS

Various exemplary embodiments, features, and aspects of the invention will be described in detail below with reference to the drawings.

It is to be understood that the following embodiments are not intended to limit the claims of the present invention, and that not all of the combinations of the aspects that are described according to the following embodiments are necessarily required with respect to the means to solve the problems according to the present invention.

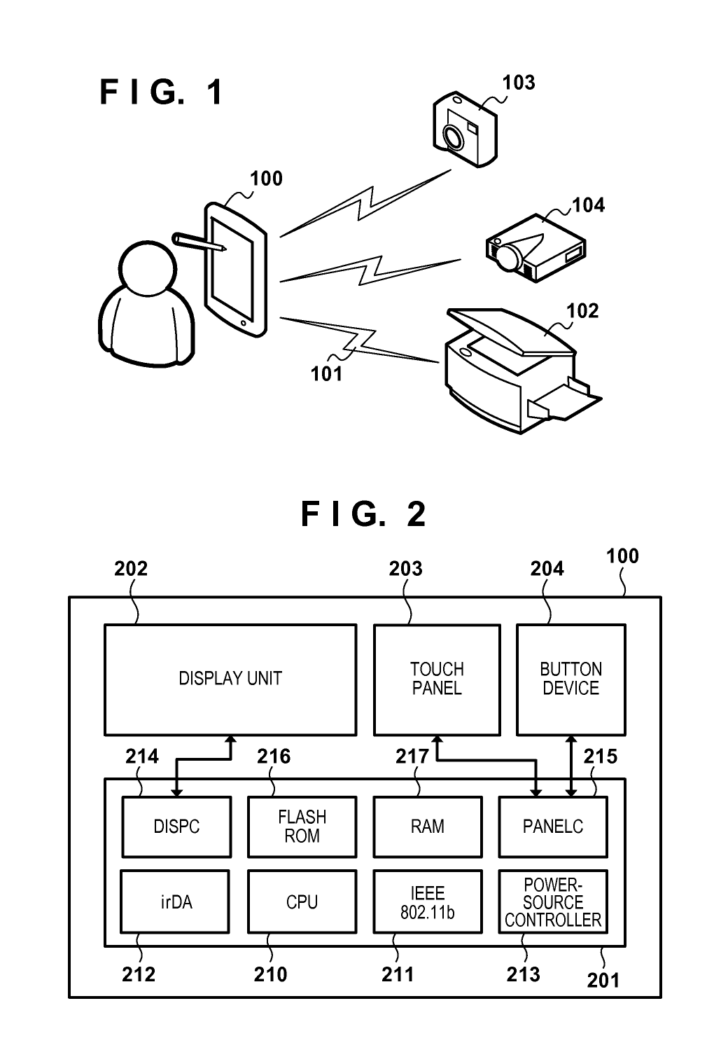

FIG. 1 is a schematic view illustrating an environment in which use is made of an information terminal (information processing apparatus) equipped with a touch screen according to an embodiment of the present invention.

An information terminal 100 has been connected to an image forming apparatus (a multifunction peripheral, for example) 102, a digital camera 103 and a projector 104 via a wireless LAN 101. As a result, the information terminal 100 can receive scan data that has been read in by the image forming apparatus 102 and data such as job history from the image forming apparatus 102 and can display such data on the information terminal 100. Further, image data can be transmitted from the information terminal 100 to the image forming apparatus 102 and printed by the image forming apparatus 102. Furthermore, the information terminal 100 is capable of receiving image data captured by the digital camera 103 or of transmitting image data to the projector 104 and causing the projector to display the image represented by the image data. An embodiment set forth below will be described taking as an example an application for a case where the information terminal 100 is combined with the image forming apparatus 102. It should be noted that although the method of connecting to the information terminal 100 is illustrated taking the wireless LAN 101 as an example, the connection can be achieved by another method such as by making use of a wired LAN.

FIG. 2 is a block diagram illustrating the hardware configuration of the information terminal 100 according to an embodiment.

The information terminal 100 primarily has a main board 201, a display unit (LCD) 202, a touch panel 203 and a button device 204. It should be noted that the touch panel 203 is transparent, placed on the screen of the display unit 202 and outputs an on-screen position designated by a finger or pen or the like.

The main board 201 mainly has a CPU 210, an IEEE 802.11b module 211, an IrDA module 212, a power-source controller 213 and a display controller (DISPC) 214. The main board 201 further includes a panel controller (PANELC) 215, a flash ROM 216 and a RAM 217. These components are connected by a bus (not shown).

The CPU 210 exercises overall control of the devices connected to the bus and executes firmware as a control program that has been stored in the flash ROM 216. The RAM 217 provides the main memory and work area of the CPU 210 and a display memory for storing video data displayed on the display unit 202.

In response to a request from the main board 201, the display controller 214 transfers image data, which has been expanded in the RAM 217, to the display unit 202 and controls the display unit 202. The panel controller 215 transmits a pressed position, which is the result of a designating member such as a finger or stylus pen contacting the touch panel 203, to the CPU 210. Further, the panel controller 215 sends the CPU 210 a key code or the like corresponding to a key pressed on the button device 204.

The CPU 210 is capable of detecting the following operations performed using the touch panel 203: a state (referred to as “touch down”) in which the touch panel 203 is being touched by a finger or pen; the fact (referred to as “move”) that a finger or pen is being moved while in contact with the touch panel 203; the fact (referred to as “touch up”) that a finger or pen that had been in contact with the touch panel 203 has been lifted; and a state (referred to as “touch off”) in which the touch panel 203 is not being touched at all. These operations and position coordinates at which the touch panel 203 is being touched by the finger or pen are communicated to the CPU 210 through the bus and, based upon the information thus communicated, the CPU 210 determines what kind of operation was performed on the touch panel. As for “move”, the determination can be made also for every vertical component (“y coordinate” below) and horizontal component (“x coordinate” below) with regard to the direction of movement of the finger or pen, which is moved on the touch panel 203, based upon a change in the coordinate position. Further, it is assumed that a stroke has been made when “touch up” is performed following a regular “move” after a “touch down” on the touch panel 203. A very quick stroke action is referred to as a “flick”. Specifically, “flick” is an operation in which, with fingers in contact with the touch panel, the fingers are moved rapidly over a certain distance and then lifted. In other words, this is a rapid tracing operation in which the fingers are flicked across the surface of the touch panel. The CPU 210 can determine that a “flick” has been performed when it detects such movement over a predetermined distance or greater and at a predetermined speed or greater and then detects “touch up”. Further, the CPU 210 can determine that “drag” has been performed if it detects movement over a predetermined distance or greater and then detects “touch on”. Further, it is possible for the touch panel 203 to sense multiple pressed positions simultaneously, in which case multiple items of position information concerning the pressed positions are transmitted to the CPU 210. It should be noted that the touch panel 203 may employ a method that relies upon any of the following: resistive film, electrostatic capacitance, surface acoustic waves, infrared radiation, electromagnetic induction, image recognition and optical sensing.

The power-source controller 213 is connected to an external power source (not shown) and is thus supplied with power. As a result, the power-source controller 213 supplies power to the entire information terminal 100 while it charges a charging battery (not shown) connected to the power-source controller 213. If power is not supplied from the external power source, then power from the charging battery is supplied to the overall information terminal 100. Based upon control exercised by the CPU 210, the IEEE 802.11b module 211 establishes wireless communication with an IEEE 802.11b module (not shown) of the image forming apparatus 102 and mediates communication with the information terminal 100. The IrDA module 212 makes possible infrared communication with the irDA module of the digital camera 103, by way of example.

### First Embodiment

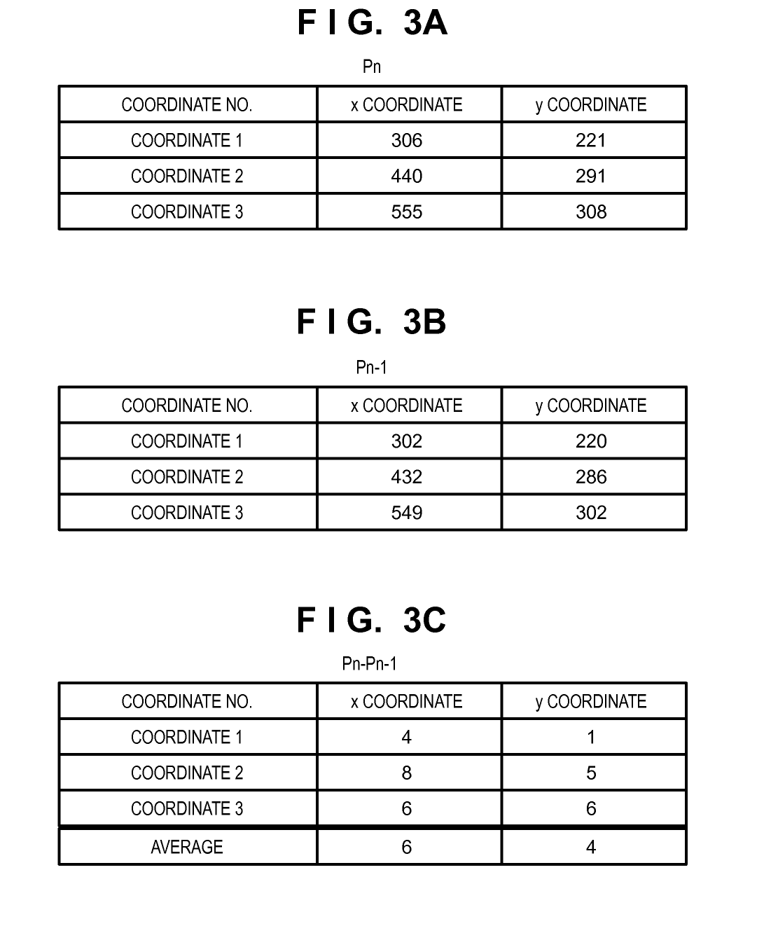

Reference will now be had to FIGS. 3A to 7 to describe scroll processing in the information terminal 100 according a first embodiment of the present invention. It should be noted that the processing according to this embodiment is implemented by the software of the information terminal 100 but may just as well be implemented by hardware.

FIGS. 3A to 3C are diagrams useful in describing an example of position information representing positions where the touch panel 203 is being touched by fingers.

FIG. 3A illustrates position information Pn indicative of positions being touched by fingers at a certain point in time. Here coordinates 1, 2 and 3 indicate coordinate values of coordinates being touched by three fingers. FIG. 3B illustrates position information Pn-1 immediately preceding that of FIG. 3A, and coordinates 1, 2 and 3 indicate coordinate values of coordinates being touched by three fingers. FIG. 3C illustrates amount of deviation (amount of movement) of coordinates between FIG. 3A and FIG. 3B.

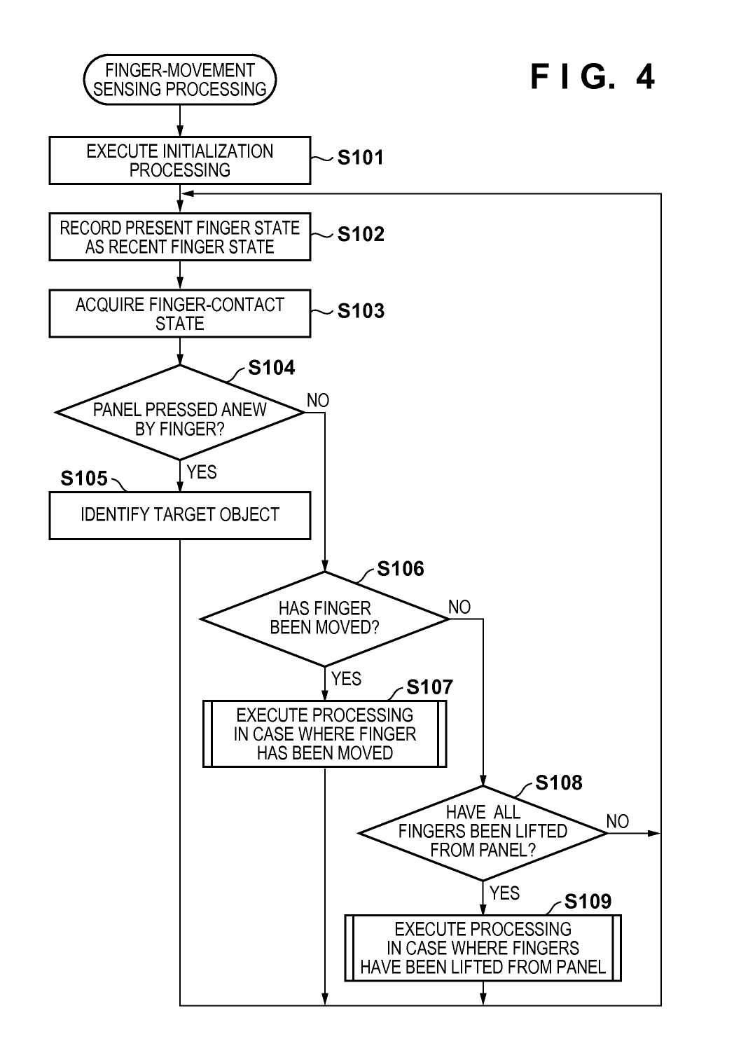

FIG. 4 is a flowchart useful in describing an example in which the state of contact between the touch panel 203 and fingers is sensed and processing conforming thereto is executed in the information terminal 100 according to the first embodiment of the present invention. This processing is executed in a case where an application that necessitates processing for moving an object by finger or pen or the like has been launched, and the processing is executed continuously until the application is quit. Although a case where the touch panel 203 is touched by a finger will be described here, another body such as a stylus pen may also be used. It should be noted that the program for executing this processing has been stored in the flash ROM 216 and is implemented by running the program under the control of the CPU 210.

First, at step S101, the CPU 210 executes initialization processing for initializing to “0”, and then storing in the RAM 217, the position information Pn, which is indicative of positions on the touch panel 203 being touched by fingers, and a finger count Fn, which indicates the number of fingers touching the touch panel 203. Next, at step S102, the CPU 210 stores the position information Pn and finger count Fn, which have been stored in the RAM 217, and a sensing time Tn, in the RAM 217 as the immediately preceding position information Pn-1, immediately preceding finger count Fn-1 and immediately preceding sensing time Tn-1, respectively, and increments the variable n. At this time the values of Pn-1, Fn-1 and Tn-1 are stored as Pn-2, Fn-2 and Tn-2, respectively. That is, when expressed in general terms, the values of Pn-m+1, Fn-m+1 and Tn-m+1 are stored as Pn-m, Fn-m and Tn-m, respectively. As a result, sensed information thus far in an amount corresponding to a predetermined period of time is stored as Pn-m, Fn-m and Tn-m. Here m is a value representing how many times ago a sensing operation was performed. For example, Pn-3 signifies position information that was sensed three sensing operations ago.

Next, at step S103, the CPU 210 acquires from the panel controller 215 the present state of finger contact with the touch panel 203 and stores this in the RAM 217. At this time the position information sent from the touch panel 203 is treated as Pn and the number of items of position information is treated as the finger count Fn (detection of number of fingers). The time at which this is sensed is stored as Tn.

Next, at step S104, the CPU 210 investigates whether there has been an increase in the number of items of position information, namely in the number of fingers touching the touch panel 203, proceeds to step S105 if the touch panel 203 is touched by a finger anew and proceeds to step S106 otherwise. As for the specific criteria, the CPU 210 determines that the touch panel 203 has been touched by a finger anew if the immediately preceding finger count Fn-1 is “0” and the present finger count Fn is “1” or greater.

At step S105, the CPU 210 identifies the object to be manipulated and stores this in the RAM 217. The method of identifying the object to be manipulated can be set appropriately in accordance with the application. For example, the object is identified as an object being displayed topmost on the screen of the display unit 202 in dependence upon the center position of the coordinates of the fingers touching the touch panel 203. As another example, the object is identified as a list object, which contains an object being displayed topmost on the screen of the display unit 202, at the center position of the coordinates of the fingers touching the touch panel 203.

When touching anew by a finger is not detected at step S104, control proceeds to step S106, where the CPU 210 determines whether fingers touching the touch panel 203 thus far have been moved on the touch panel 203. If movement of fingers is determined, control proceeds to step S107; otherwise, control proceeds to step S108. Sensing of finger movement on the touch panel 203 is performed by comparing the coordinate values of each finger contained in the immediately preceding position information and the coordinate values contained in the present position information of each corresponding finger. If there is even one pair of compared coordinate values that do not match, then the CPU 210 determines that the fingers touching the panel have been moved. For example, the x coordinate of coordinate 1 in FIG. 3A is “306” and the x coordinate of coordinate 1 in FIG. 3B is “302”; these to not match. In this case, the CPU 210 determines that the finger corresponding to coordinate 1 has been moved on the touch panel 203. In the examples of FIGS. 3A to 3C, movement is indicated for all of the coordinates 1 to 3 and therefore the CPU 210 determines that three fingers are being moved on the touch panel 203.

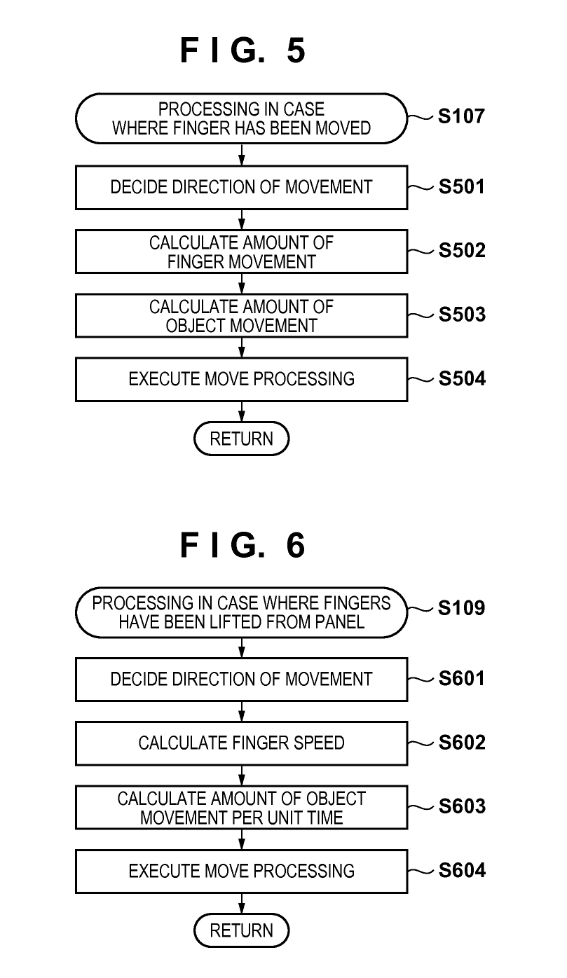

At step S107, the CPU 210 executes processing, which will be described later with reference to FIG. 5, in a case where it has been determined that a finger has been moved.

At step S108, the CPU 210 investigates whether all fingers have been lifted from the touch panel 203. Control proceeds to step S109 if lifting of all fingers has been sensed and to step S102 otherwise. Specifically, at step S108, if the immediately preceding finger count Fn-1 of fingers contacting the touch panel 203 is “1” or greater and the present finger count Fn is “0”, then the CPU 210 determines that all of the fingers have been lifted from the panel. At step S109, the CPU 210 executes processing for a case where separately decided fingers have been lifted from the touch panel 203. It should be noted that, at step S109, it is assumed that when all fingers are lifted from the touch panel 203, a finger-flicking action will be performed next on the screen of the touch panel 203.

FIG. 5 is a flowchart useful in describing processing, which corresponds to the processing of step S107 in FIG. 4, in a case where fingers touching a touch panel are moved in the first embodiment.

First, at step S501, the CPU 210 decides the possible direction of movement of the object being touched by these fingers. There are cases where the direction in which this object can be moved is decided depending upon the target object decided at step S105 in FIG. 4 described above. For example, if the object is a list, then, in general, the object can only be moved in the direction in which the elements constituting the list are arranged. Accordingly, by acquiring information on possible direction of movement based upon the object decided at step S105, the CPU 210 decides whether the direction in which the object can be moved is along the x direction, y direction or all directions.

Next, control proceeds to step S502, at which the CPU 210 calculates the amount of movement of the fingers moved on the touch panel 203. Here the CPU 210 calculates the coordinate-value differences between the x coordinates and between the y coordinates of each finger from the present position information Pn and immediately preceding position information Pn-1.

FIG. 3C illustrates the results, thus found, of calculating the differences between the coordinate values of each of the fingers. The CPU 210 further calculates, for every x coordinate and every y coordinate, the average values of the differences between the coordinate values corresponding to the three fingers. The average values shown in FIG. 3C indicate the results. Specifically, FIG. 3C indicates that the average values of the amounts of movement of the three fingers are “6” along the x direction and “4” along the y direction. It should be noted that calculation of amounts of movement in directions other than the direction of movement decided at step S501 is omitted. For example, if the object moves only along the x direction, then the amount of movement along the y direction need not be calculated.

Next, at step S503, the CPU 210 calculates the amount of movement of the target object. It is assumed that the amount of movement of this object is obtained by multiplying the amount of finger movement by a function of the number of fingers. Specifically, amount Dn of an object at an nth detection is represented by Dn=(Pn−Pn-1)×f(Fn), where f(Fn) is a function of the finger count Fn. The simplest function as the function f(Fn) is the finger count per se, namely f(Fn)=Fn. In this case, the amount Dn of movement of the object is Dn=(Pn−Pn-1)×Fn.

In a case where it is desired to increase the amount of movement of an object with respect to the amount of finger movement, it is possible to implement this by applying a function such as f(Fn)=2×Fn, by way of example. Here f(Fn) or Dn is capable of being changed freely in accordance with the application. Examples in which these are changed will be described in second and third embodiments, set forth later. A case where use is made of Dn=(Pn−Pn-1)×Fn will now be described as an example of a method of calculating the amount of movement of an object. In FIG. 3C, amount of finger movement is “6” along the x direction and “4” along the y direction, as mentioned above. Further, the finger count Fn is “3”. The amount Dn of movement of the object in this case, therefore, is 6×3=18 along the x direction and 4×3=12 along the y direction.

Next, at step S504, the CPU 210 executes processing for moving the object. The position of the object is being retained in the same coordinate system as that of the position information. For example, if the position information of the object and the position information of the position being touched by a finger match, it can be said that the object and the finger are present at the same position. Further, movement of the object becomes possible by changing the coordinate values of the object to thereby re-render the object. At step S504, the CPU 210 adds the amount of movement obtained at step S503 to the coordinate values of the object and again executes processing for rendering the object, thereby implementing movement of the object. It should be noted that the addition to the coordinate values is performed only with respect to the direction found at step S501.

FIG. 6 is a flowchart useful in describing processing in a case where fingers are lifted at step S109 in FIG. 4, namely processing in a case where fingers are flicked across the touch panel 203.

First, at step S601, the CPU 210 decides whether the direction of movement of the object is along the x direction, y direction or all directions in a manner similar to that at step S501 in FIG. 5. Next, at step S602, the CPU 210 calculates the speed of finger movement. Calculation of the speed of finger movement is carried out using past items of position information Pn-m and sensing times Tn-m that were acquired a predetermined number of times as well as immediately preceding position information Pn-1 and sensing time Tn-1. By dividing the average values of the differences (Pn-1−Pn-m) between the finger-by-finger coordinate values of these items of data by the time (Tn-1−Tn-m) needed for such movement, speed per unit time is obtained.

Next, at step S603, the CPU 210 multiplies the moving speed per unit time obtained at step S602 by past finger counts Fn-m that were acquired a predetermined number of times and stores the result in the RAM 217 as the amount of movement of the object per unit time. It should be noted that although the amount of movement is calculated based upon the finger moving speed and number of fingers, the present invention is not limited to this arrangement. For example, acceleration rather than moving speed may be found at step S602 and amount of movement may be decided from acceleration and the number of fingers.

Next, at step S604, the CPU 210 moves the object repeatedly, in the direction found at step S601, at a prescribed display updating period by the amount of movement of the object per unit time found at step S603. It should be noted that the amount of movement every display updating period is changed appropriately in accordance with the speed per unit time updated every sensing time Tn.

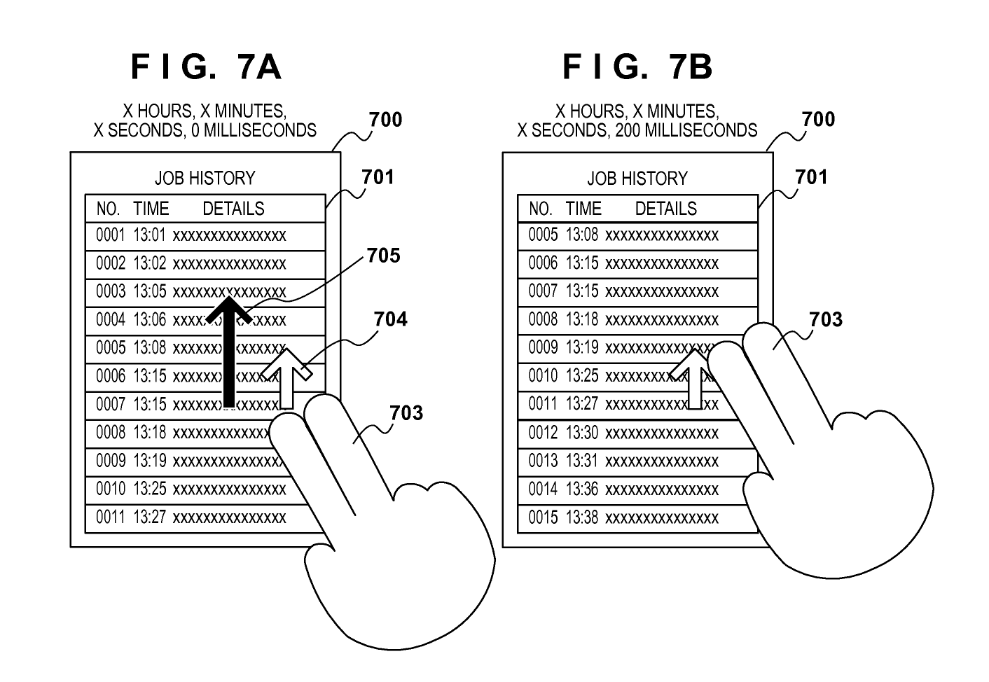

FIGS. 7A and 7B are diagrams useful in describing an example in which a screen is scrolled by moving contacting fingers on a job history screen 700, which indicates past job information, displayed on the display unit 202 of an information terminal according to the first embodiment.

The job history information is acquired by the image forming apparatus 102 via the IEEE 802.11b module 211 using a well-known method. Although job history is illustrated here as one example of an object to be manipulated, anything may be the target of manipulation. For example, the object to be manipulated ma be an image such as a photograph or a Web page.

Reference will be had to FIGS. 7A and 7B to describe in detail the positional relationship between fingers and the object to be moved in a case where the flow of processing for detecting finger movement in FIG. 4 is applied. It should be noted that an example in which the move processing of FIG. 5 (step S107) conforming to number of fingers is applied and an example in which the finger-flicking processing of FIG. 6 (step S109) is applied will be described in detail.

FIG. 7A represents a state in which two fingers contact a job list, which represents the contents of job history, at a time of X hours, X minutes, X seconds and 0 milliseconds. FIG. 7B, which illustrates the condition which prevails at a time of X hours, X minutes, X seconds and 200 milliseconds, indicates that fingers 703 have been moved from FIG. 7A in the direction of the white arrow 704. When finger movement from the state of FIG. 7A is sensed, the move processing indicated by the flowchart of FIG. 5 is executed in the finger movement detection processing of step S107 in FIG. 4.

The fact that the job list is moved only up and down is designated in advance. As a result, the direction of movement is decided upon as the y direction at step S501. Further, the amount of movement of finger 703 found at step S502 is equivalent to two lines of the job list (the difference from the leading end to the trailing end of the white arrow 704). Furthermore, by multiplying the amount of finger movement by the number “2” of fingers at step S503, the amount of movement of the object becomes four lines of the job list. Consequently, the job list is scrolled by four lines along the y direction at step S504, as indicated by black arrow 705.

Pressing by fingers 703 is detected only twice, namely before and after movement. However, as mentioned above, processing for detecting finger movement in FIG. 4 is performed repeatedly at predetermined intervals. Since this interval usually is sufficiently short, there is the possibility that processing (FIG. 5) in a case where fingers conforming to the number of fingers have been moved will be executed a plurality of times during the transition from the state of FIG. 7A to the state of FIG. 7B. In this case also, however, if the difference relative to the immediately preceding position is calculated at each moment of detection and this move processing is executed on each such occasion, then ultimately movement will take place up to the same position. Hence, the result will be unchanged.

It should be noted that if the interval at which pressing by the finger is detected is sufficiently short, then, in a case where a finger is lifted from the touch panel in mid-course or a contacting finger is added on, what is affected by the number of fingers is the amount of movement at each moment move processing is executed. Therefore, by increasing or decreasing the number of fingers while finger movement is in progress, it is possible to raise or lower the speed of object movement.

A situation where all fingers are lifted from the touch panel immediately after the condition shown in FIG. 7B will be considered below. When all fingers are lifted from the touch panel, processing (FIG. 6) in the case where fingers are lifted from the touch panel is executed at step S109.

As mentioned above, the fact that the job list is moved only up and down is designated in advance. As a result, the direction of movement is decided upon as the y direction at step S601. Assume that finger sensing is performed once every 20 ms and that the number of items of old data (the above-mentioned predetermined number thereof) referred to at step S602 is “10”. In this case, data from 200 ms previously (namely the condition shown in FIG. 7A) is compared with the immediately preceding data (the condition shown in FIG. 7B) at step S602. When these two are compared, it will be understood that since the fingers are moving (the white arrow 704) by two lines of the list in 200 ms, the fingers are moving at a speed of 10 lines/second.

Furthermore, at step S603, this speed is multiplied by “2”, which is the number of fingers, so that the amount of object movement per unit time thus decided is 20 lines/second. At step S604, the job list is scrolled at this speed every display updating period. For example, if the display updating period is 50 ms, then the job list is scrolled by 20 lines/second×0.05=1 line every display updating period (50 ms).

In accordance with the first embodiment as described above, by changing the number of fingers that contact the touch panel in a scroll operation or move operation, it is possible to change this manipulated variable (amount of movement). This makes it possible for the user to display the target data or location in a shorter period of time in a case where a list containing a large quantity of data is scrolled or in a case where a very large image (a map image, for example) is moved.

Further, since changing the manipulated variable only involves changing the number of fingers, it can be achieved simply and easily. In addition, since the amount of change is an intuitive amount of change, namely a multiple of the number of fingers or a fixed number of times the number of fingers, a more user-friendly scroll operation or movement of an object can be realized.

### Second Embodiment

A second embodiment of the present invention will be described next. It should be noted that the configuration of the information terminal 100 in the second embodiment is the same as that in the first embodiment and is not described again.

The second embodiment illustrates move control processing in an application that requires precise manipulation. In the first embodiment, the amount of object movement was obtained by multiplying the amount of finger movement by the number of fingers in move processing (FIG. 5) conforming to the number of fingers. The purpose was to move a large quantity of data faster.

In the second embodiment, on the other hand, the purpose is to implement precise manipulation and, hence, the amount of object movement at step S503 is obtained by dividing the amount of finger movement by the number of fingers. That is, in the formula for calculating amount Dn of object movement, f(Fn)=1/Fn is utilized and therefore the formula is Dn=(Pn−Pn-1)/Fn. This amount of movement is added to the coordinate values of the object at step S504. It should be noted that the coordinate values of the object are held internally as real-number values, and it is possible to retain information below the decimal point as well. Only the integer part is used at the time of display.

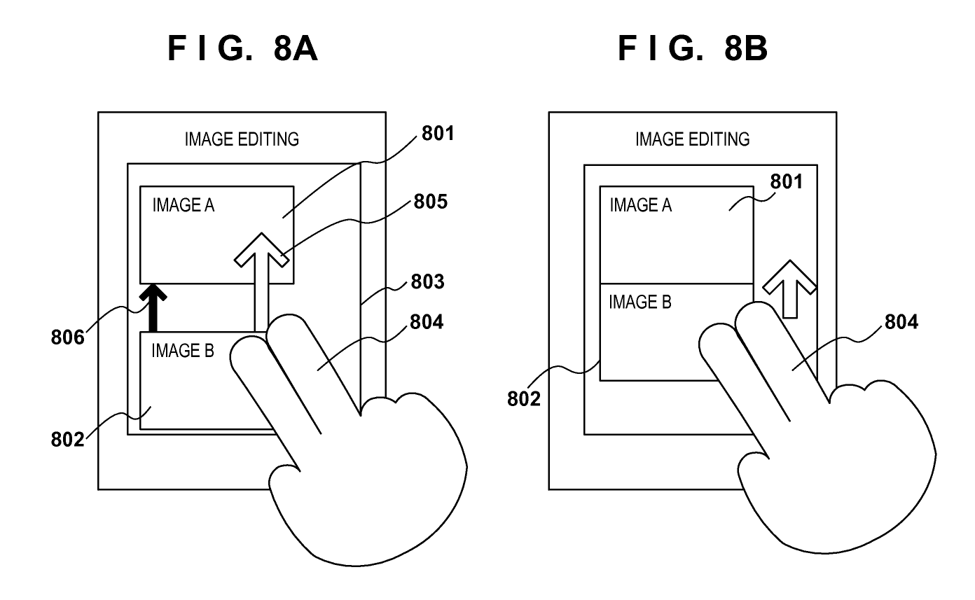

A specific example will now be illustrated using FIGS. 8A and 8B.

FIGS. 8A and 8B are diagrams useful in describing movement of an image on the display unit 202 of the information terminal 100 according to the second embodiment. Here two images [image A (801) and image B (802)] are being displayed as image editing screens. By performing a drag operation, the user can move these two screens to any location inside an editing area 803. FIG. 8A illustrates a state in which fingers 804 are touching the image B (802), and FIG. 8B illustrates the situation that prevails after fingers 804 have been moved from the state of FIG. 8A in the manner indicated by the white arrow 805.

If the amount of object movement at step S503 is obtained by dividing the amount of finger movement by the number of fingers, then, since the number of fingers is two, the amount of object movement will be half the amount of finger movement (the distance from the leading end to the trailing end of the white arrow 805), as indicated by the black arrow 806. As a result, the image B (802) will be moved to the position adjacent the image A (801), as shown in FIG. 8B.

As mentioned earlier, a change in amount of object movement achieved by changing the number of fingers that touch the touch panel is reflected immediately after the change in number of fingers. In FIG. 8A, for example, assume that the user wishes to make image B (802) adjoin image A (801) perfectly. By using one finger to manipulate image B (802) until it is closer to image A (801), the object [image B (802) in this case] can be moved by an equal amount of movement. When image B (802) approaches image A (801) and comes to occupy a position requiring fine adjustment, the number of fingers touching the touch panel is made two. As a result, it is possible to manipulate the object using one-half the amount of movement.

Depending upon the case, other coordinates may be sensed when the fingers are lifted and, as a consequence, there is a possibility that the object will be moved beyond the position prevailing after fine adjustment. This problem can be solved by adding on processing for finalizing movement of the object if the at-rest state of the fingers continues for a predetermined period of time following the fine adjustment. Alternatively, it may be arranged so that a move finalizing button is provided and the position of the image undergoing movement is finalized when this button is pressed during fine adjustment.

In accordance with the second embodiment as described above, if a user wishes to perform an operation for precise movement of an object, the user increases the number of fingers that touch the touch panel, thereby decreasing the amount of object movement relative to the amount of finger movement and making it possible to finely adjust the amount of movement of the object. As a result, precise positional adjustment of an object will be possible even for a user utilizing a touch screen having a low coordinate sensing accuracy or for a user who finds it difficult to finely adjust finger position. This enhances convenience. For example, in the case of a terminal for which the coordinate sensing accuracy of the touch panel is low and sensed coordinate values always fluctuate on the order of one pixel even when fingers are at rest, if four fingers are used, this error will be reduced to one-fourth the original error, thus facilitating precise manipulation. Similarly, even if fingers tremble, as when manipulation is attempted in an attitude where fine adjustment of finger position is difficult, or because of some physical reason, it is possible to diminish the effects of such finger trembling by increasing the number of fingers that contact the touch panel. This has the effect of enhancing operability.

### Third Embodiment

Next, a third embodiment for implementing the present invention will be described. It should be noted that the configuration of the information terminal 100 in the third embodiment is the same as that in the first and second embodiments and is not described again.

In the third embodiment, control processing in an application that requires an electronic-document page-turning operation will be described as an example of application of the invention in another application.

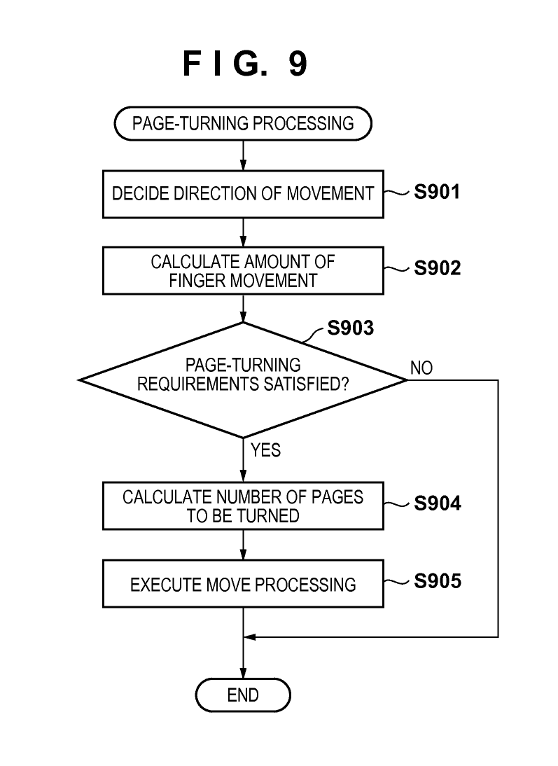

FIG. 9 is a flowchart useful in describing page-turning processing conforming to number of fingers used in an information terminal according to the third embodiment. It should be noted that the program for executing this processing has been stored in the flash ROM 216 and is implemented by running the program under the control of the CPU 210. The processing executed at steps S901 and S902 in FIG. 9 is equivalent to that executed at steps S501 and S502, respectively, in FIG. 5. Following step S902, control proceeds to step S903, where the CPU 210 determines whether to execute page-turning processing by way of the present operation. Specifically, first the CPU 210 determines whether a fingers have been moved a predetermined distance or greater with respect to the positions pressed by the fingers. If it is determined that fingers have not been moved a predetermined distance or greater, then the CPU 210 decides not to execute page-turning processing. Further, if the page presently being displayed is the final page and there are no further pages to be turned, then the CPU 210 decides not to execute page-turning processing. Further, the CPU 210 decides not to execute page-turning processing in a case where turning of a page has already been executed in the present drag operation. That is, page-turning processing is not executed twice once fingers have been lifted from the touch panel. The CPU 210 determines whether to execute page turning based upon these requirements and control proceeds to step S904 if execution of page-turning processing is determined. If it is determined not to execute page-turning processing, then page-turning processing is terminated.

At step S904, the CPU 210 adopts the finger count Fn as the amount of page movement (the number of pages to be turned). Next, control proceeds to step S905, where the CPU 210 executes pre-defined page moving processing a number of times equivalent to the number of pages found at step S905. Here the method of displaying turned pages does not matter. The image of the page at the destination of movement may simply be displayed at the same position as that of the present page image, and an animation that makes it appear that the image is being turned during this processing may be added on.

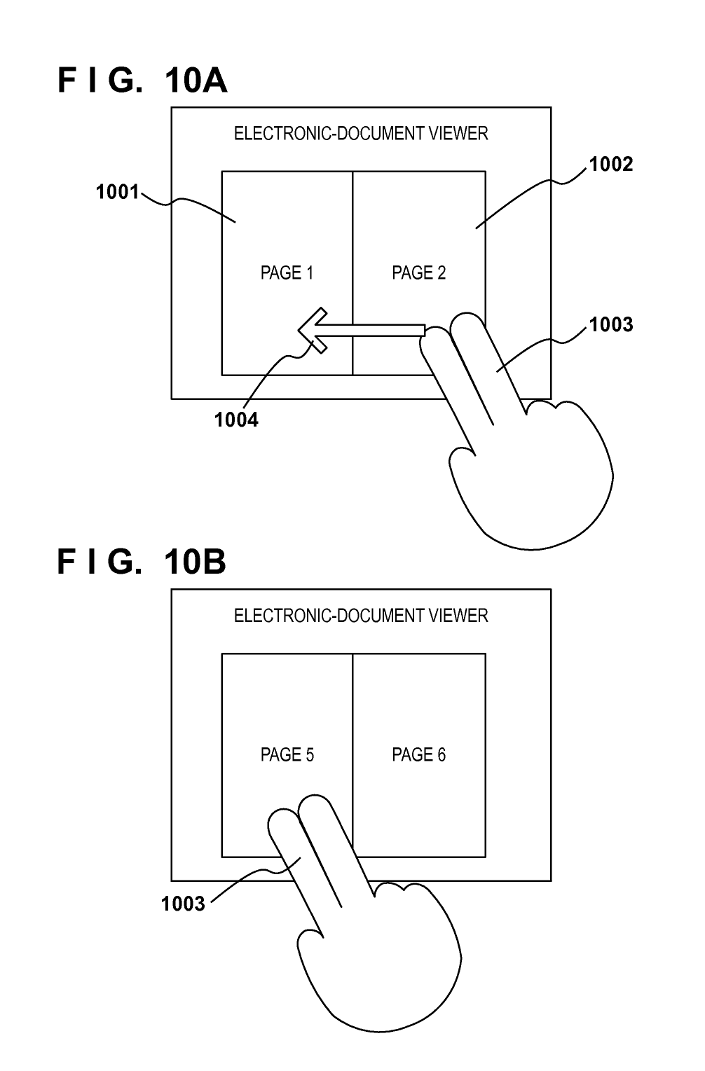

A specific example will now be displayed with reference to FIGS. 10A and 10B.

FIGS. 10A and 10B are diagrams useful in describing page-turning processing according to the third embodiment. FIGS. 10A and 10B illustrate a state in which two page images [page 1 (1001) and page 2 (1002)] are being displayed as an electronic-document viewer screen on the display unit 202 of the information terminal 100. The user can perform a page-turning operation by using fingers to perform a drag operation leftward on page 2 (1002). FIGS. 10A and 10B illustrate the relationship between finger movement and the display screen before and after a page-turning operation, respectively. When fingers 1003 are moved as indicated by white arrow 1004, it is decided at step S904 that the number of pages turned is “2” in accordance with the number of fingers touching the touch panel. Next, at step S905, page moving processing equivalent to two pages is executed. Thus, eventually, as shown in FIG. 10B, a state will be obtained in which pages 5 and 6 are displayed, this being the result of turning pages equivalent to two pages relative to the state shown in FIG. 10A.

In accordance with the third embodiment as described above, by changing the number of fingers contacting the touch panel in a page-turning operation, the user can change the number of pages turned. As a result, since the user can turn pages in an amount equivalent to the number of fingers contacting the touch panel, it is possible to achieve a page-turning operation that is more intuitive.

It should be noted that, in the foregoing first to third embodiments, an example has been described in which a touch panel is contacted by fingers. However, this does not impose a limitation upon the present invention, for a body such as a pen may be used to contact the touch panel. An arrangement may be adopted in which, when multiple bodies are contacting the touch panel, the number of these can be distinguished.

In accordance with the embodiments described above, it is possible for a user to display target data or a location in a shorter period of time in a case where a list containing a large quantity of data is scrolled or in a case where a very large image (a map image, for example) is moved. Further, precise positional adjustment of an object is possible even for a user utilizing a touch screen having a low coordinate sensing accuracy or for a user who finds it difficult to finely adjust finger position. This enhances convenience.

### Other Embodiments

Although the present invention has been described in detail based upon preferred embodiments thereof, the present invention is not limited to these specific embodiments and various embodiments the scope of which does not depart from the gist of the present invention are covered by the present invention. Further, parts of the foregoing embodiments may be combined appropriately.

Further, the above-described information processing apparatus includes apparatuses of various types. For example, these are not limited to a personal computer or PDA or mobile telephone terminal but also include printers, scanners, facsimile machines, copiers, multifunction peripherals, cameras, video camera and other image viewers and the like.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-251021, filed Nov. 16, 2011, which is hereby incorporated by reference herein in its entirety.

What is claimed is:

1. An information processing apparatus having a display unit equipped with a touch panel, comprising:
a movement detection unit configured to detect amount of movement of a body contacting the touch panel;
a number detection unit configured to detect a number of bodies contacting the touch panel;
an identification unit configured to identify an object being displayed on the display unit, the object having been designated by a body contacting the touch panel; and
a control unit configured to decide a manipulated variable of the object and control display of the object in accordance with the amount of movement detected by said movement detection unit and the number of bodies detected by said number detection unit.

2. The apparatus according to claim 1, wherein the manipulated variable is found by multiplying the amount of body movement by a function of the number of bodies, and said control unit moves the object in accordance with the manipulated variable.

3. The apparatus according to claim 1, wherein the manipulated variable is a value obtained by dividing the amount of body movement and a function of the number of bodies, and said control unit moves the object in accordance with the manipulated variable.

4. The apparatus according to claim 1, further comprising a speed calculation unit configured to obtain moving speed of a body contacting the touch panel;
wherein said control unit scrolls the object based upon a function of the number of bodies and the moving speed.

5. The apparatus according to claim 1, further comprising a calculation unit configured to calculate a number of pages of the object to be turned, in a case where the object indicates pages, based upon moving direction of a body contacting the touch panel and number of bodies contacting the touch panel;
wherein said control unit adopts the number of pages, which have been calculated by said calculation unit, as the manipulated variable, and presents a display so as to turn the pages of the object in accordance with the number of pages.

6. A method of controlling an information processing apparatus having a display unit equipped with a touch panel, the method comprising the steps of:
detecting amount of movement of a body contacting the touch panel;
detecting a number of bodies contacting the touch panel;
identifying an object being displayed on the display unit, the object having been designated by a body contacting the touch panel; and
deciding a manipulated variable of the object and controlling display of the object in accordance with the amount of movement detected and the number of bodies detected.
